(19) United States
(12) Patent Application Publication
(10) Pub. No.: US 2009/0160644 A1
(43) Pub. Date: Jun. 25, 2009

(54) Active Tags

(75) Inventor: Xiaohui YANG, Los Altos, CA (US)

Correspondence Address: SILICON VALLEY PATENT AGENCY, 7394 WILDFLOWER WAY, CUPERTINO, CA, 95014, US

(73) Assignee: WG Security Products Inc., San Jose, CA (US)

(21) Appl. No.: 11/963,829

(22) Filed: Dec. 22, 2007

(51) Int. Cl. G08B 13/14

(52) U.S. Cl. 340/571

(57) ABSTRACT

Active tags are disclosed. According to one aspect of the present invention, an active tag is made similar to a shell in shape. The tag includes two parts, one is referred to as a cover and the other one is referred to as a base. The base includes a trigger tip (e.g., a reset switch) that is engaged when the two parts are closed. In an exemplary application, the needle of the cover part goes through a piece of garment and is engaged into the cover. These two parts can be disengaged by a detacher that is typically controlled by a casher (e.g., at point of sale). One of the important features in the present invention is that the tag is active, which means the shell tag will set off an alarming audio if disengaged improperly or without authorization.

### BACKGROUND

1. Technical Field

The present invention is generally related to prevention devices that deter shoplifting. Particularly, the present invention is related to active tags, where the active tags may be attached to items that must be checked out through required means, otherwise the active tags may set off an alarm.

2. Description of the Related Art

Shoplifting in sales outlets, and particularly in retail sales outlets, is a significant problem adversely affecting both sellers and consumers. To deter shoplifting, some sales outlets employ electronic article surveillance (EAS) systems that include transponder tags attached to each article of merchandise in the sales outlet. EAS systems further include one or more electronic readers positioned at exits from the sales outlet to detect the transponder tags. When a customer purchases an article, the transponder tag is disabled or removed from the article and the customer passes by the reader and out the exit of the sales outlet without sounding an alarm. When a shoplifter attempts to remove an article from the sales outlet without paying, the reader detects the transponder tag that has not been disabled or removed from the article and sounds the alarm. Sales or security personnel in the sales outlet are alerted by the alarm, enabling them to apprehend the shoplifter and recover the merchandise.

Although EAS systems are effective in reducing losses incurred by sales outlets due to theft of merchandise without payment, retail sales outlets employing EAS systems remain susceptible to other forms of shoplifting. For example, a potential shoplifter may remove a transponder tag that is being attached to an article of merchandise before passing the EAS system, in which case the EAS could no longer detect the presence of the transponder tag and the merchandise might be taken away without being paid.

There is a need for alternative solutions that at least make the removal of a tag from an article of merchandise difficult, and make an alarm sound off should such attempt be made.

### SUMMARY

This section is for the purpose of summarizing some aspects of embodiments of the present invention and to briefly introduce some preferred embodiments. Simplifications or omissions in this section as well as in the title and the abstract of this disclosure may be made to avoid obscuring the purpose of the section, the title and the abstract. Such simplifications or omissions are not intended to limit the scope of the present invention.

Broadly speaking, the present invention is related to active tags. According to one aspect of the present invention, an active tag is made similar to a shell in shape. The tag includes two parts, one is referred to as a cover and the other one is referred to as a base. The base includes a trigger tip (e.g., a reset switch) that is engaged when the two parts are closed. In an exemplary application, the needle of the cover part goes through a piece of garment and is engaged into the cover. These two parts can be disengaged by a detacher that is typically controlled by a casher (e.g., at point of sale). One of the important features in the present invention is that the tag is active, which means the shell tag will set off an alarming audio if disengaged improperly or without authorization.

Embodiments of the invention may be implemented in numerous ways, including a method, system, device, or a computer readable medium. Several embodiments of the invention are discussed below. In one embodiment, the invention provides a method for providing an advertisement according to a category matching, the method comprises: obtaining a copy of data traffic initiated by a user; analyzing the copy of data traffic to update or locate a profile of the user; determining a first category in the profile of the user; locating a second category that corresponds to the first category, wherein there is at least an advertisement registered with the second category; determining the advertisement in the second category; and publishing the advertisement in a webpage sent to the user.

There are numerous objects, features, and advantages in the present invention. These objects, features, and advantages will become apparent upon examining the following detailed description of various embodiments thereof, taken in conjunction with the attached drawings.

### BRIEF DESCRIPTION OF THE DRAWINGS

The invention will be readily understood by the following detailed description in conjunction with the accompanying drawings, wherein like reference numerals designate like structural elements, and in which:

FIG. 1 shows an exemplary shell tag according to one embodiment of the present invention;

FIG. 2 shows that a shell tag (e.g., the base part) includes an audio hole, a receiver and a transmitter;

FIG. 3A shows a block diagram of the electronic part in the shell tag in accordance with the present invention;

FIG. 3B shows a sensor that may be used in the electronic part of the shell tag of FIG. 3A;

FIG. 4 shows three perspective views of a detacher in accordance with one exemplary embodiment; and

FIG. 5 shows a flowchart of operating the active shell tags according to one embodiment of the present invention.

### DETAILED DESCRIPTION OF THE INVENTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

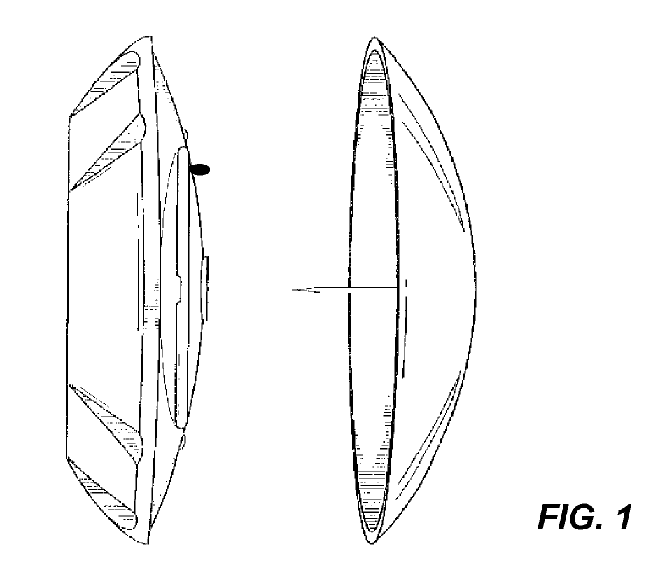

Embodiments of the present invention are discussed herein with reference to FIGS. 1-5. However, those skilled in the art will readily appreciate that the detailed description given herein with respect to these figures is for explanatory purposes as the invention extends beyond these limited embodiments.

FIG. 1 shows an exemplary shell tag 100 according to one embodiment of the present invention. The shell tag includes two parts 102 and 104, one is referred to as a cover and the other one is referred to as a base. The base 104 includes a trigger tip 106 (e.g., a reset switch) that is engaged when the two parts 102 and 104 are closed. In an exemplary application, the needle 108 of the cover part 102 goes through a piece of garment (not shown) and is engaged into the base 104. These two parts 102 and 104 can be disengaged by a detacher that is typically controlled by a casher (at point of sale, for example).

Occasionally, a prior art shell tag might be disengaged by a portable detacher brought in by a shoplifter, resulting in a loss of the garment. One of the important features in the present invention is that the shell tag 100 as shown in FIG. 1 is active, which means the shell tag 100 will set off an alarming audio if disengaged improperly or without authorization. It should be appreciated to those skilled in the art that an active shell tag 100 as illustrated in FIG. 1 is only one type of format implementing the present invention. An active tag may be implemented in other forms as long as there are two pieces. When these two pieces are engaged, a trigger tip is pressed to keep an alarm inside quite. When these two pieces are disengaged before a circuit inside is disabled, the alarm will be set to be off (making an alarming audible sound). Depending on an article or an object to be protected, the tag can be designed accordingly. For easy description in reference to FIG. 1, a shell tag will be herein referred to without the loss of generality.

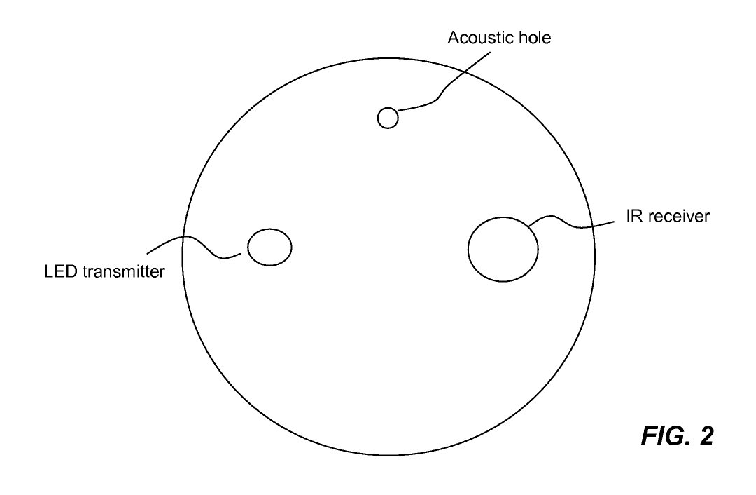

According to one embodiment as shown in FIG. 2, a shell tag 200 (e.g., the base part) includes an audio hole, a receiver and a transmitter. The audio hole is to propagate the alarming audio generated in a circuit inside the base part. The receiver and the transmitter are provided to exchange electronic information with a detacher that is uniquely designed to disengage such a shell tag.

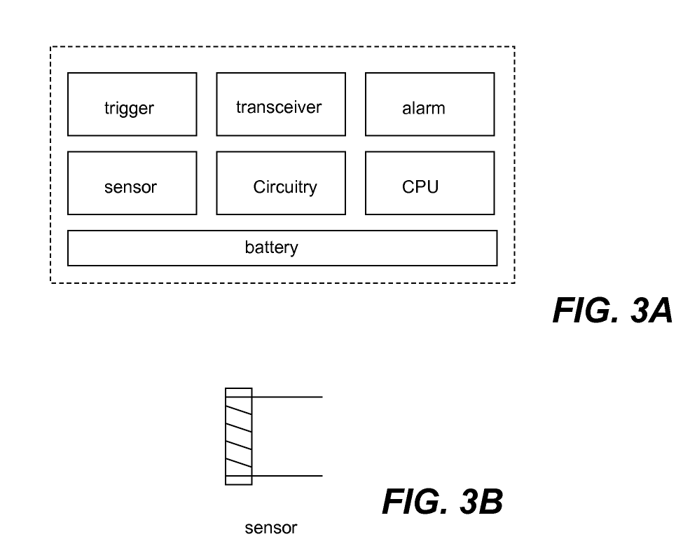

FIG. 3A shows a block diagram 300 of the electronic part in the shell tag in accordance with one embodiment of the present invention. The trigger 302 is a switch that is turned off when the cover is engaged with the base and turned on when the cover is disengaged or taken off from the base. Physically, the trigger 302 is pushed down when the cover is engaged with the base, and the trigger is released when the cover is disengaged or taken off the base.

Without authorized disengagement of the shell tag, a released trigger will cause the circuitry to operate. The circuitry 310 then drives the alarm to generate an alarming audio. When the engaged shell tag is brought to an authorized detacher for disengagement, as part of the transceiver 304, a transmitter of the shell tag transmits a sequence of code to the detacher that responds with a command to be received by the receiver of the shell tag after recognizing the shell tag. Upon receiving the command by a receiver (part of the transceiver 304), the CPU 312 executes a set of instructions to turn off the circuitry. Now the shell tag can be disengaged without setting off the alarm.

The sensor 308 is also included to prevent an article of garment with an engaged shell tag to be brought out from a premise without authorization. According to one embodiment, the sensor 308 includes a transponder (e.g., an inductor enhanced by a conductive rod to increase the inductance thereof), an example of such an inductor is shown in FIG. 3B. When the shell tag enters a surveillance area guarded by an electronic article surveillance (EAS) system (e.g., U.S. Pat. No. 6,753,821), the EAS system will be set off to produce an alarm audio.

Depending on an exact implementation of the shell tag 100 of FIG. 1, besides the features that are shown in FIG. 3A, additional features of the shell tag in accordance with the present invention include at least the following:
Active reusable tags made of fire retardant plastic;
Capable of interacting with a special detacher;
Communicating with a special detacher via infrared beams;
Each tag coded specifically for each location;
Extra strength lock with strong locking mechanism;
Strong construction made of scratch and tamper resistant material; and
Simple to attach and easily removed with a special detacher.

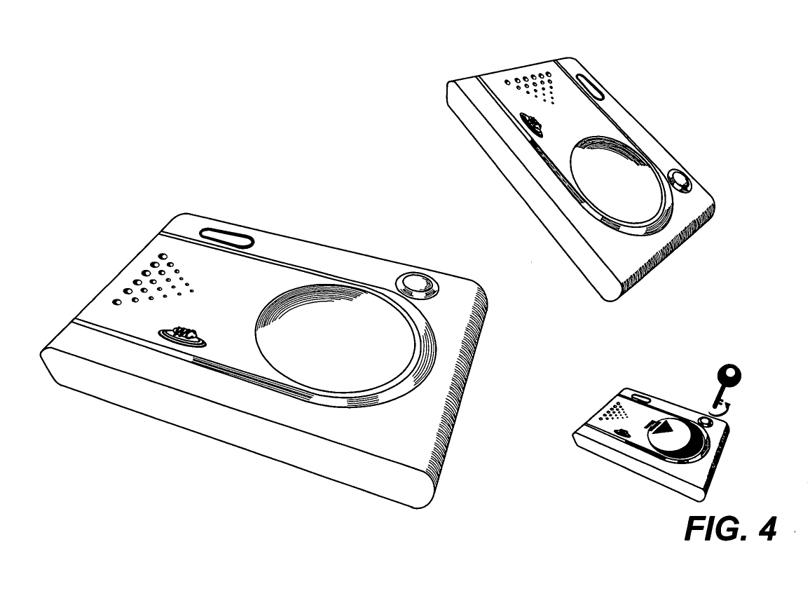

FIG. 4 shows three perspective views of a detacher in accordance with one exemplary embodiment. The detacher includes a surface for a shell tag to be placed one. When an engaged shell tag is placed on the surface or in the processing of placing the shell tag on the surface, a transmitter (e.g., a corresponding IR transmitter, not specifically shown) of the detacher communicates with the receiver of the shell tag to disable the circuitry therein, provided that the coded information has been verified on both sides. The lock mechanism in the shell tag is then released (i.e., the cover is disengaged from the base of the shell tag).

Also not shown in FIG. 4 is an interface (e.g., USB) equipped on the detacher. Through the interface, coded information may be provided to the detacher that may at the same time operate as an activator. For example, a particular store desires to encode a special code in tags across the store to distinguish from tags possibly from other places. Through the activator, all the tags can be loaded with information specially designed for the store. Only those tags loaded with the special code could be disengaged by the detacher.

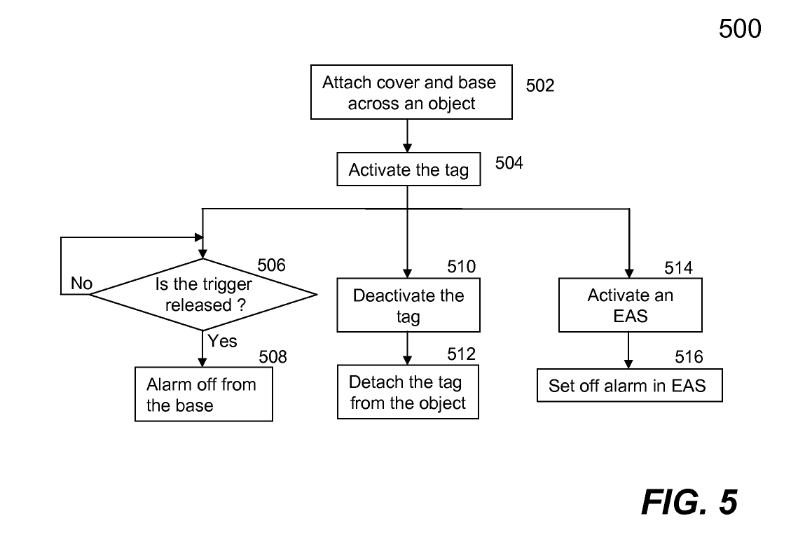

FIG. 5 shows a flowchart 500 of operating the active shell tags according to one embodiment of the present invention. The flowchart 500 can be implemented as a device, a part of system and a method. At 502, a shell tag including a cover and a base is placed on an object (e.g., a piece of clothing). The tag is then activated by an activator at 504, namely, the tag is loaded with specially coded information (or a sequence of codes).

At this time, any unlawful disengagement of the shell tag would cause the inside circuitry to produce an alarming audio. At 506, the process 500 determines whether the engaged tag has been disengaged. If it does, the tip on the base facing the cover would be released, which will cause the alarm inside to go off at 508 to draw attention from others.

It is assumed that the object is brought to an authorized POS where there is a detacher. The activated shell tag is placed on the detacher, where a disengaging signal is generated from the detacher and received in the activated shell tag. The received disengaging signal causes the activated shell tag to be inactivated at 510. The unlocking mechanism (e.g., magnets) in the detacher then unlocks the cover from the base of the shall tag at 512. So the object without the shell tag could be removed from a designed location (e.g., a store).

In another situation, the object with an activated shell tag is being removed out of the location unlawfully. When the object enters an EAS system placed at the exit, the sensor in the tag that is still on the object can trigger the EAS to set off the alarm system. In operation, the sensor in the tag is charged by the electromagnetic field generated the EAS, the energized sensor via the circuitry inside in return produces signals that, once received, trigger the EAS system.

The processes, sequences or steps and features discussed above and in the appendixes are related to each other and each is believed independently novel in the art. The disclosed processes and sequences may be performed alone or in any combination to provide a novel and unobvious system or a portion of a system. It should be understood that the processes and sequences in combination yield an equally independently novel combination as well, even if combined in their broadest sense; i.e. with less than the specific manner in which each of the processes or sequences has been reduced to practice in the attached appendixes.

While the embodiment discussed herein may appear to include some limitations as to the presentation of the information units, in terms of the format and arrangement, the invention has applicability well beyond such embodiment, which can be appreciated by those skilled in the art.

The forgoing and attached are illustrative of various aspects/embodiments of the present invention, the disclosure of specific sequence/steps and the inclusion of specifics with regard to broader methods and systems are not intended to limit the scope of the invention which finds itself in the various permutations of the features disclosed and described herein as conveyed to one of skill in the art.

I claim:

1. An active tag comprising:
a cover and a base to be engaged;
circuitry that produces an alarming audio when the cover and base are disengaged prior to the circuitry being disabled, wherein the circuitry communicates with an external device to receive coded information via an infrared interface, when checking out at an authorized detacher, the circuitry is disabled upon receiving a command after the coded information received from the tag and verified in the authorized detacher.

2. The active tag as recited in claim 1 further comprising a trigger tip that is engaged when the cover and the base are engaged, and that is released when the cover and the base are disengaged.

3. The active tag as recited in claim 2, wherein the cover and the base are engaged mechanically through a needle that goes through an article of merchandise.

4. The active tag as recited in claim 3, further comprising a circuit that generates an alarm when the cover and the base are disengaged without an aid of a detacher.

5. The active tag as recited in claim 4, wherein the circuit is disabled when the cover and the base are disengaged with a detacher.

6. The active tag as recited in claim 1 further comprising a transponder that activates an electronic article surveillance (EAS) system if the transponder is brought nearby.

7. The active tag as recited in claim 6, wherein the active tag is removed from an article of merchandise to avoid being close to the EAS system.

8. The active tag as recited in claim 1 further comprising a trigger tip that is engaged when the cover and the base are engaged, and that is released when the cover and the base are disengaged, wherein the trigger tip is coupled to a circuit designed to set off an alarm if the cover and the base are disengaged without proper authorization.

9. The active tag as recited in claim 8, wherein the circuit is disabled when the cover and the base are disengaged with a detacher.

10. The active tag as recited in claim 9, further comprising a transceiver designed to communicate with the detacher to transmit a signal to the detacher for recognition or to receive a signal to disable the circuit when the active tag is brought to the detacher.

11. The active tag as recited in claim 10, wherein the detacher is also used to code the active tag so that the active tag becomes valid only in one predefined premise.

12. The active tag as recited in claim 10, wherein the active tag is made shell-like in shape.

13. The active tag as recited in claim 10, wherein the active tag is made out of a type of fire retardant plastic material.

14. The active tag as recited in claim 10, wherein the active tag is simple to attach and easily be removed with a special detacher.

15. The active tag as recited in claim 10, wherein the active tag is designed to communicate with a special detacher via infrared beams;
